(19) United States
(12) Patent Application Publication
(10) Pub. No.: US 2016/0355365 A1
(43) Pub. Date: Dec. 8, 2016

(54) TAPE DISPENSER, CUTTING BLADE AND METHOD

(71) Applicant: Thogus Products Company, Avon Lake, OH (US)

(72) Inventor: Gregory J. Werner, Brunswick, OH (US)

(21) Appl. No.: 15/144,416

(22) Filed: May 2, 2016

Related U.S. Application Data
(60) Provisional application No. 62/169,552, filed on Jun. 2, 2015.

(51) Int. Cl. B65H 35/00; B29C 45/40

(52) U.S. Cl. CPC B65H 35/008; B65H 35/0026; B29C 45/40; B33Y 80/00

(57) ABSTRACT

A cutting blade includes a blade support and a plurality of teeth forming a serrated front portion of the blade support. At least one of the plurality of teeth has a length extending in a direction transverse of the blade support and terminating in a pointed tip.

### RELATED APPLICATIONS

This patent application claims priority to Application Ser. No. 62/169,552 entitled “Tape Dispenser, Cutting Blade and Method” filed on Jun. 2, 2015 the entirety of which is incorporated by reference herein.

### FIELD OF THE INVENTION

The present invention relates generally to a tape dispenser, a cutting member and a method of making and using a tape dispenser and cutting blade.

### BACKGROUND

Tape dispenser assemblies are commonly used for a variety of consumer and industrial applications. The tape dispenser assemblies vary widely in design and construction and typically include a tape dispenser made of metal or plastic material and having an attached metal blade for cutting. The metal blades have sharp edges and are designed to penetrate a variety of tape materials and thicknesses. Tape dispensers made of polymers with attached metal blades require elaborate manufacturing procedures, such as insert molding, or post-molding procedure, both of which add to manufacturing cost, complexity, and time. Tape dispensers that have polymer blades have been unsuitable for many applications, such as tape dispensers that apply, for example, packaging tape, which is made of thick films of strong materials. Cutting blades, more generally, are typically made of metal. Plastic cutting blades either lack the ability to cut effectively or are made of moving parts which are prone to breakage.

### SUMMARY

In one example embodiment of the present invention, a tape dispenser comprises a first sidewall, a second sidewall, and a cutting blade integral with the first and second sidewalls. The cutting blade includes a plurality of teeth. In another example embodiment the tape dispenser is made of polymer.

In another embodiment, a cutting blade comprises a blade support and a plurality of teeth that form a serrated front portion of the blade support. Each of the plurality of teeth terminates in a pointed tip.

In yet another embodiment, a tape dispenser comprises a first sidewall, a second sidewall, and a cutting blade including a plurality of teeth. Each tooth includes a tip. The tape dispenser also comprises a support member for rotatable supporting a roll of adhesive tape in the tape dispenser between the first and second sidewalls. The tape dispenser further comprises a guide member for helping to guide a length of the adhesive tape away from the support member such that the length of adhesive tape passes adjacent the cutting blade with an adhesive side surface of the adhesive tape presented in a direction away from the cutting blade. Each of the plurality of teeth projects in a direction toward the length of adhesive tape such that the tip of each tooth is closer to the length of adhesive tape than any other portion of the tooth. At least one of the plurality of teeth includes a cutting surface extending in a direction away from the tip of said at least one tooth and in a direction toward the support member.

In still another embodiment, a method for manufacturing a tape dispenser includes manufacturing a tape dispenser body and cutting blade as a unitary tape dispenser. In one example the tape dispenser is made in an injection molding process, and in another example the tape dispenser is made in an additive or 3D printing process.

In yet a further embodiment, a method of cutting a length of adhesive tape comprising the step of passing the adhesive tape in a first direction adjacent a plurality of teeth projecting in a second direction toward the adhesive tape such that a tip of each tooth is closer to the adhesive tape than any other portion of the tooth. At least one of the plurality of teeth includes a cutting surface extending in a third direction away from the tip of said at least one tooth and away from the first direction. The method also comprises the step of moving the adhesive tape and/or the plurality of teeth relative to one another so that the tip of each tooth contacts the adhesive tape. The method further comprises the step of applying pressure to the adhesive tape through the plurality of teeth a the tip of at least one tooth and/or the cutting surface of at least one tooth passes through adhesive tape.

### BRIEF DESCRIPTION OF THE DRAWINGS

The various embodiments of the present invention can be understood with reference to the following drawings. The components in the drawings are not necessarily to scale. Also, in the drawings, like reference numerals designate corresponding parts throughout the several views.

FIG. 1 is a front perspective of a tape dispenser including a cutting blade, according to an example embodiment of the present invention;

FIG. 2 is a rear perspective of the tape dispenser of FIG. 1;

FIG. 3 is an enlarged rear perspective view of the cutting blade of the tape dispenser of FIG. 1;

FIG. 4 is a front elevation view of the tape dispenser of FIG. 1;

FIG. 5 is a sectional view taken along line 5-5 of FIG. 4;

FIG. 6 is an enlarged view of a portion of FIG. 5 illustrating an individual tooth of cutting blade of the tape dispenser of FIG. 1;

FIG. 7 is a front view taken along line 7-7 of FIG. 6;

FIG. 8 is a sectional view taken along line 8-8 of FIG. 7;

FIG. 9 is a sectional view taken along line 9-9 of FIG. 6;

FIG. 10 is a bottom view taken along line 10-10 of FIG. 6;

FIG. 11 is a rear perspective view of the tooth of FIG. 6;

FIG. 12 is a sectional view taken along line 12-12 of FIG. 7;

FIG. 13 is a front perspective view of a portion of a cutting blade of a tape dispenser according to a second example embodiment of the present invention;

FIG. 14 is a rear perspective view of a portion of the cutting blade of the tape dispenser of FIG. 12;

FIG. 15 is a top view of a tooth of the cutting blade of the tape dispenser of FIG. 12;

FIG. 16 is a bottom view of a tooth of the cutting blade of the tape dispenser of FIG. 12; and

FIG. 17 is a front elevation view of a tooth of the cutting blade of the tape dispenser of FIG. 12.

### DETAILED DESCRIPTION

Various example embodiments of a cutting blade, a product dispenser, a tape dispenser, and methods for manufacturing and using a cutting blade and tape dispenser are disclosed herein. Particular embodiments of cutting blade will be described below in relation to its applications in a tape dispenser and in a packaging tape dispenser; however, it will be appreciated that the present invention could be employed across a variety of industrial and consumer applications where cutting blades, product dispensers and tape dispensers are commonly employed. For example, cutting blades and dispensers with cutting blades can be used in products that are available in rolls, including but not limited to, paper sheets, films of polymer, thin sheets or films of metal, adhesive-backed substrates such as polymer or paper substrates, and tape, for example, and which are cut into smaller pieces. Examples of polymer sheet or film includes, but is not limited to, stretch wrap, sheet or film comprising polyvinylidene chloride (PVDC), linear low-density polyethylene, polyvinylchloride (PVC), and combinations thereof, for example. Examples of paper products that can be dispensed from a roll include, but are not limited to, wrapping paper, parchment paper, freezer-wrap or butcher paper, and wax paper, for example.

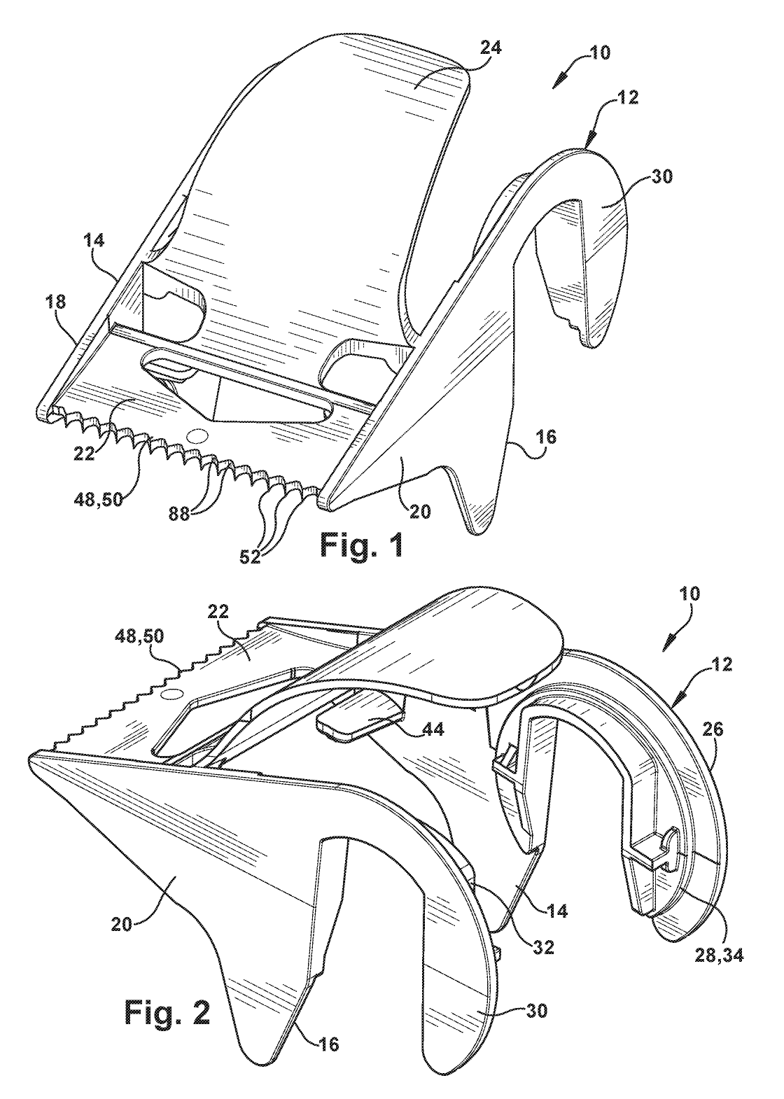

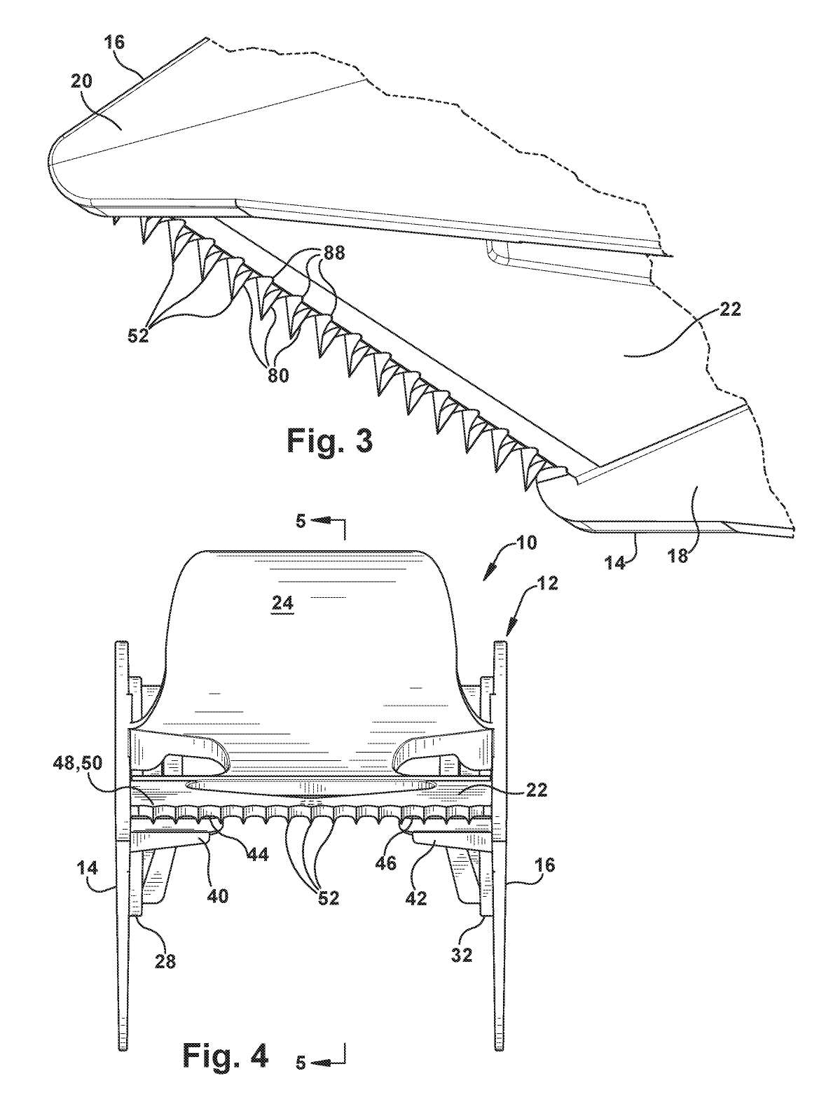

FIGS. 1-11 illustrate a tape dispenser 10, according to an example embodiment of the present invention. The tape dispenser 10 includes a body or frame 12 molded of polymeric material. The frame 12 includes a left sidewall 14 and aright sidewall 16. The left and right sidewalls 14 and 16 are spaced laterally apart from one another and are oriented generally parallel to one another. A forward first end portion 18 of the left sidewall 14 is joined to a forward first end portion 20 of the right sidewall 16 by a blade support portion 22 of the frame 12. The first end portions 18 and 20 of the left and right sidewalls 14 and 16, respectively, are also joined together by an upwardly curved palm support portion 24 of the frame 12, which can be received in the palm of a user of the tape dispenser 10.

A rearward second end portion 26 of the left sidewall 14 includes a left roll support 28 that projects toward the right sidewall 16. A rearward second end portion 30 of the right sidewall 16 similarly includes a right roll support 32 that projects toward the left sidewall 14. The left and right roll supports 28 and 32 include support surfaces 34 and 36, respectively, that rotatably support an inner cylindrical surface of a core 37 (FIG. 4) on which a roll of adhesive tape 38 is wound. To help guide or control the position of the adhesive tape 38 as it is unwound from the core 37, the first end portion 18 of the sidewall 14 and the first end portion 20 of the right sidewall 22 include left and right guide tabs 40 and 42, respectively. The left guide tab 40 projects toward the right sidewall 16, and the right guide tab 42 projects toward the left sidewall 14. As the adhesive tape 38 is unwound from the core 37 mounted on the left and right roll supports 28 and 32, the adhesive tape passes over, but may not touch curved upper surfaces 44 and 46 of the left and right guide tabs 40 and 42, respectively. The left and right guide tabs 40 and 42 help ensure that a length of adhesive tape 38 being unwound from the roll of adhesive tape passes adjacent the cutting blade 50 with an adhesive side surface 39 of the adhesive tape presented in a direction away from the cutting blade.

A forward end portion 48 of the blade support 22 is formed as a cutting blade 50. The blade support 22, including the cutting blade 50, like the frame 12, is formed of a polymeric material. As shown, the blade support 22, including the cutting blade 50, is formed in one piece with the frame 12, including the left and right sidewalls 14 and 16 and the palm support portion 24. In other words, tape dispenser 10, including the cutting blade 50, is a single unitary piece or member or a single body of polymeric material, such as a thermoplastic or thermoset polymer, for example. The tape dispenser 10 can be manufactured in a single unit via, for example, injection molding or additive manufacturing (also known as 3D printing). The polymer, polymeric material or material composition may be same for all portions of the tape dispenser 10, including the cutting blade 50. Alternatively, the cutting blade 50 and the remainder of the tape dispenser 10 may be made of different materials, which may be two different polymers or a metal for the cutting blade 50 and a polymer for the remainder of the tape dispenser 10, including the portion of the blade support 22 other than the cutting blade 50.

Suitable polymers from which the tape dispenser 10, including the cutting blade 50, may be formed include, but are not limited to, styrene, polyethylene, polypropylene, nylon, acrylic, polycarbonate, polyester, acrylonitrile butadiene styrene (ABS), polyvinylchloride (PVC), and blends thereof. In cutting strong tapes, such as reinforced and unreinforced packaging tape, reinforced or unreinforced, having film thicknesses of at least 1 mil, in another example thicknesses of at least 3 mils, and in another example, thicknesses that range from about 1 to 5 mils, blades made of polymers having a flexural strength that is at least about 10 kpsi or, in another example, around 10 kpsi to about 15 kpsi will allow increased strength for puncturing and cutting the tape. In yet another example, polymers having tensile strength of at least 8 kpsi can be used. Polycarbonate is a suitable for the manufacture of the tape dispenser 10, including the cutting blade 50. Polycarbonate has a typical tensile strength of 9.5 kpsi, flexural strength of 13.5 kpsi, density of 1.2 g/cc, and Rockwell R hardness of 118. It may be desirable for the tape dispenser 10 to be made of a polymer that has a flexural strength, in particular, at least as great as polycarbonate or that has at least one of flexural strength, tensile strength, and hardness that is at least as great as polycarbonate.

The cutting blade 50 includes a plurality of blade members, serrations or teeth 52. The teeth 52 are arranged in a linear array across the cutting blade 50, which extends across the lateral extent of the blade support 22. The number of teeth per lineal length of the blade 50 can vary and the size and strength of the individual teeth can affect performance. It has been found that too many teeth for a given blade length results in weak teeth that will not puncture and cut strong tapes such as packaging tape. It has also been found that a blade having too few teeth will not allow the tape to be placed and maintained in a proper position to enable puncturing by the blade and/or the tape can also hang-up along the blade making it unsuccessful for cutting. In the example blade 50 shown in FIG. 4, teeth 52 are equally spaced apart across the cutting blade 50, at a spacing that may be, for example, about 0.13 inches or 0.330 centimeters from center to center or in a range from about 0.10 inches to about 0.20 inches from center to center. For a blade width of about 2.025 inches, the number of teeth may be, for example, 15 teeth or in a range of about 10 to about 20 teeth. As illustrated, all of the teeth 52 are identical in configuration and dimensions. If desired, however, some of the teeth 52 might have a different configuration and/or different dimensions than the teeth described below.

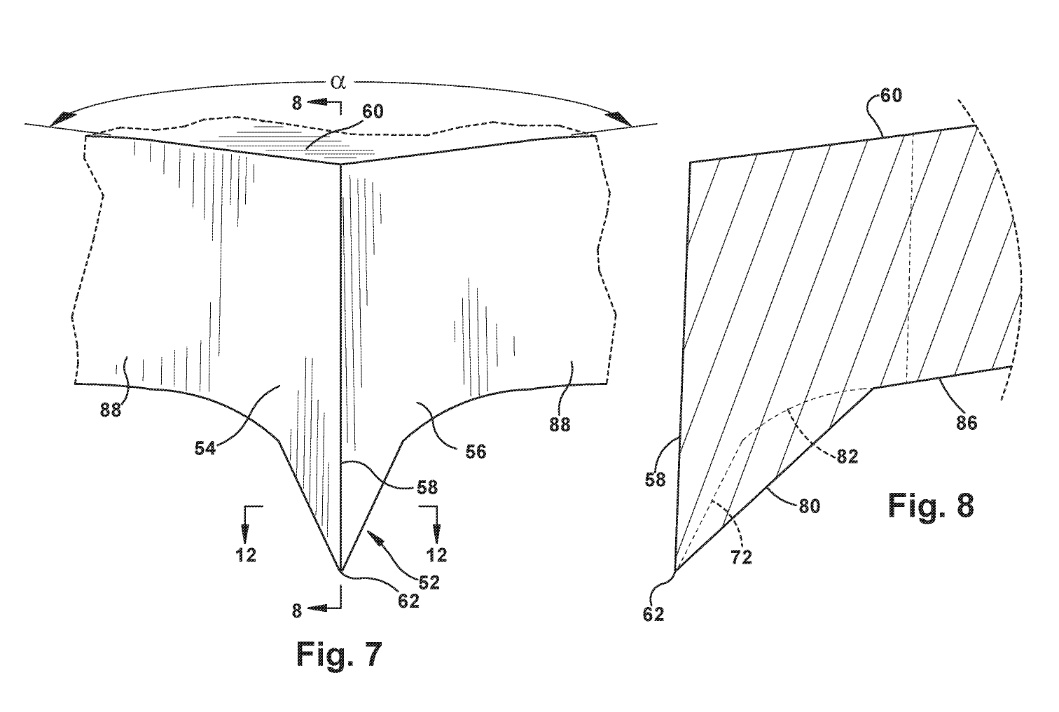

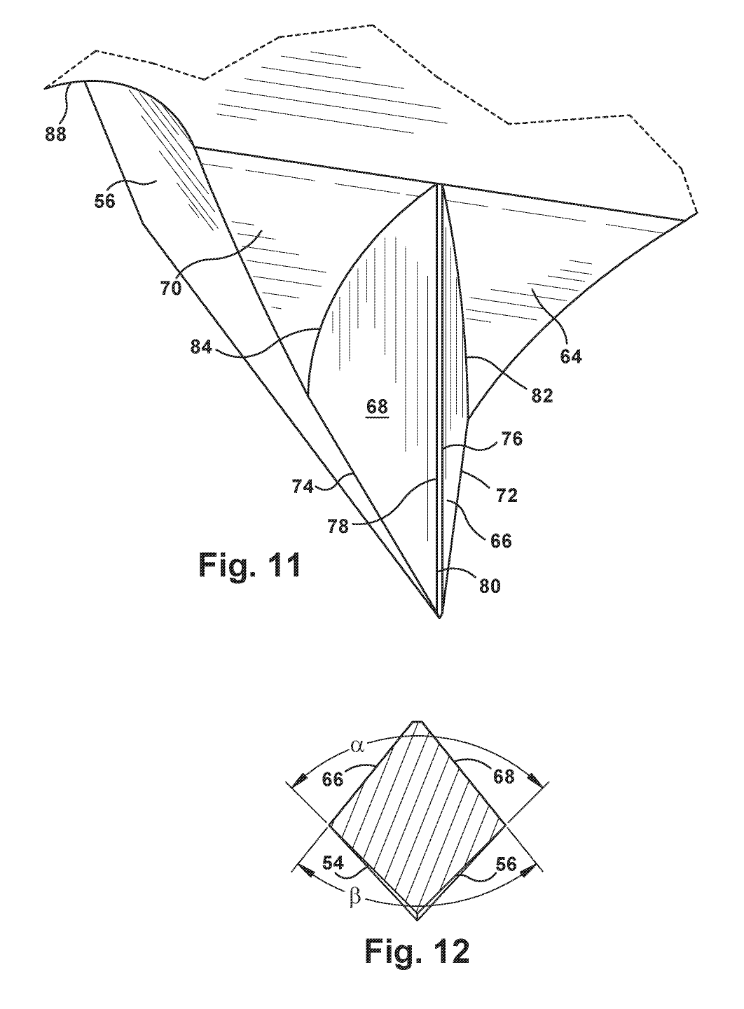

As shown in FIGS. 4 and 7, when viewed from a position in front of the tape dispenser 10 looking toward the forward end of the tape dispenser, each tooth 52 has a left front surface 54 and a right front surface 56. The left and right front surfaces 54 and 56 are substantially planar and are oriented at two different angles relative to one another in two different planes. In a horizontal plane, looking down on the tape dispenser 10, the left and right front surfaces 54 and 56 are oriented such that they come together at an edge 58 along the front of the tooth 52, as best seen in FIG. 7. The edge 58 extends from a flat upper surface 60 at the top of the tooth 52 and the cutting blade 50 to a pointed tip 62 at the bottom of the tooth. The length of tooth 52 also extends from the flat upper surface 60 at the top of the tooth 52 and the cutting blade 50 to the pointed tip 62 at the bottom of the tooth. The length of the tooth 52 thus extends in a direction transverse to the lateral extent or width of the blade support 22 and transverse to the axial extent or length of the blade support. The left and right front surfaces 54 and 56 are oriented at an angle relative to one another in a direction that is transverse to the length of the tooth, but that is parallel to or coaxial with the length of the blade support 22. The included angle between the left and right front surfaces 54 and 56 is an acute angle, marked as α in FIG. 7 and in FIG. 11, and may be, for example, about 90° or in a range of from about 95° to about 105° or in a range from about 80° to about 110°. In a vertical plane, viewed from a position in front of the tooth 52 looking toward the edge 58, the left and right front surfaces 54 and 56 are oriented such that they are slightly farther apart at the tip 62 of the tooth 52 than at the flat upper surface 60 of the tooth. The included angle, which is marked as θ in FIG. 7, between the left and right front surfaces 54 and 56 is a small acute angle and may be, for example, about 3° or in the range of from about 2° to about 6°.This included angle is provided to facilitate forming the pointed tip 62 of the tooth and also to facilitate removing the cutting blade 50 from a plastic injection mold (not shown).

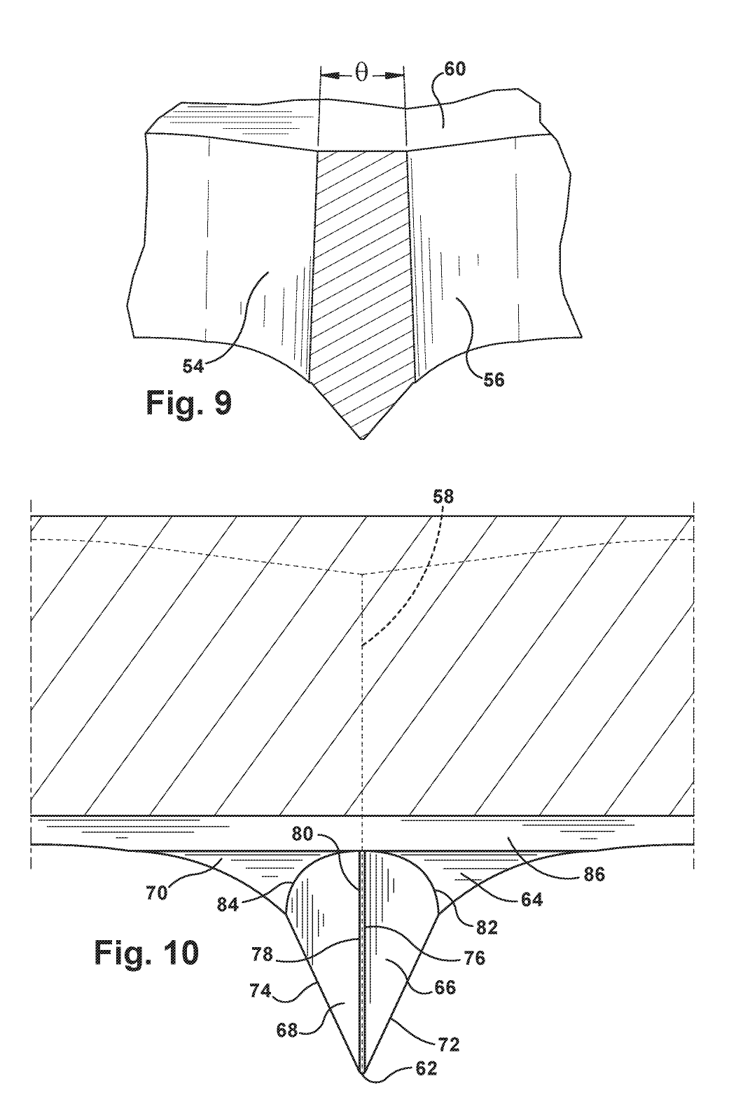

As shown in FIGS. 9 and 10, each tooth 52 also has a left rear curved surface 64, a left rear flat surface 66, a right rear flat surface 68, and a right rear curved surface 70. The left rear flat surface 66 and the right rear flat surface 68 extend away from the tip 62 of the tooth 52 and away from one another. The left and right rear flat surfaces 66 and 68 are substantially planar and have generally triangular shapes. Along one edge 72, the left rear flat surface 66 intersects the left front surface 54. Similarly, along one edge 74, the right rear flat surface 68 intersects the right front surface 56. Along a second edge 76, the left rear flat surface 66 comes close to, but does not intersect a second edge 78 of the right rear flat surface 68. Between the second edges 76 and 78 of the left and right rear flat surfaces 66 and 68, respectively, is a narrow cutting surface 80. The cutting surface 80 may be, for example, a flat surface of only about 0.0001 inch in width and thus is close to being a sharp intersection between the left and right rear flat surfaces 66 and 68, respectively. The cutting surface 80 is provided instead of a sharp edge (a) to permit polymer material to fill an injection mold properly and (b) to avoid having an edge subject to high wear. The cutting surface 80 is sufficiently narrow, nonetheless, to act as a cutting surface for adhesive tape. The cutting surface 80 extends at angle of, for example, about 45° to a horizontal or vertical plane and to the length of the tooth 52. As will be apparent from the foregoing, as best seen in FIG. 11, the left and right rear flat surfaces 66 and 68 define between them an acute angle, β, as the surfaces extend away from the narrow flat surface 80 toward the left and right front surfaces 54 and 56, respectively. Angle β may be, for example, about 100° or in a range from about 95° to about 105°.

Along a third edge 82, the left rear flat surface 66 intersects the left rear curved surface 64. Similarly, along a third edge 84, the right rear flat surface 68 intersects the right rear curved surface 70. The left and right rear curved surfaces 64 and 70 curve upward away from the left and right rear flat surfaces 66 and 68, respectively, to intersect with a flat underside surface 86 of the blade support 22. The radius of curvature of the left and right rear curved surfaces 64 and 70 can range, for example, from about 0.040 to about 0.060 inches, in another example, from about 0.043 inches to about 0.050 inches, and in another example, about 0.047 inches, and the center point 71 of the radius of curvature may be 0.044 inches to the right of the intersection 61 of the upper surface 60 of the tooth 52 and the edge 58 of the tooth and 0.100 inches below the intersection 61 of the upper surface 60 and the edge 58 of the tooth, as viewed in FIG. 8. If the left and right rear curved surfaces 64 and 70 were extended downward, as viewed in FIG. 9, for example, they would intersect the tip 62 of the tooth 52. The left and right rear curved surfaces 64 and 70 also extend laterally to intersect the left and right front surfaces 54 and 56, respectively. The flat underside surface 86 is presented in a direction away from the flat top surface 60 and extends substantially parallel to the flat top surface 60 of the tooth 52 and the cutting blade 50. The flat underside surface 86 extends from the cutting blade across the blade support 22 from the forward end portion 48 of the blade support to a rearward end portion of the blade support. The flat underside surface 86 is recessed from the tip 62 of each tooth 52. The vertical distance between the tip 62 of each tooth 52 and the flat underside surface 86 may be, for example, about 0.043 inches. The underside surface 86 of the blade support 22 is free of any projection extending vertically in the direction of the tip 62 of each tooth 52.

As can be seen from FIGS. 6-10, the left front surface 64, the right front surface 66, the left rear flat surface 66, and the right rear flat surface 68 all taper or diminish in width or lateral extent toward the tip 62 of the tooth 52, thereby forming the tip. Adjacent the forward edge 58 of the tooth 52, height of the tooth or the vertical distance between the tip 62 of the tooth and the flat top surface 60 of the tooth may be, for example, about 0.095 inches or in a range from about 0.090 to about 1.000 inches. Also, the edge 58 of the tooth 52 may be inclined slightly so that the position of the edge 58 at the intersection 61 between the edge 58 and the top surface 60 of the tooth may be, for example, about 0.004 inches to the right of the position of the edge at the tip 62 of the tooth, as viewed in FIG. 8, to facilitate removing the tooth and the cutting blade 50 from a plastic injection mold (not shown) and to increase the robustness of the tooth. The incline of the edge 58 may be at angle of, for example, about 2.25° to a vertical plane and to the length of the tooth 52. As shown in FIGS. 1, 4, and 7, the left front surface 54 of each tooth 52 is joined to the right front surface 56 of an immediately adjacent tooth by an arcuate surface 88. Each of the arcuate surfaces 88 may, alternatively, be an angled surface with an apex in what otherwise would be the center of the arcuate surface.

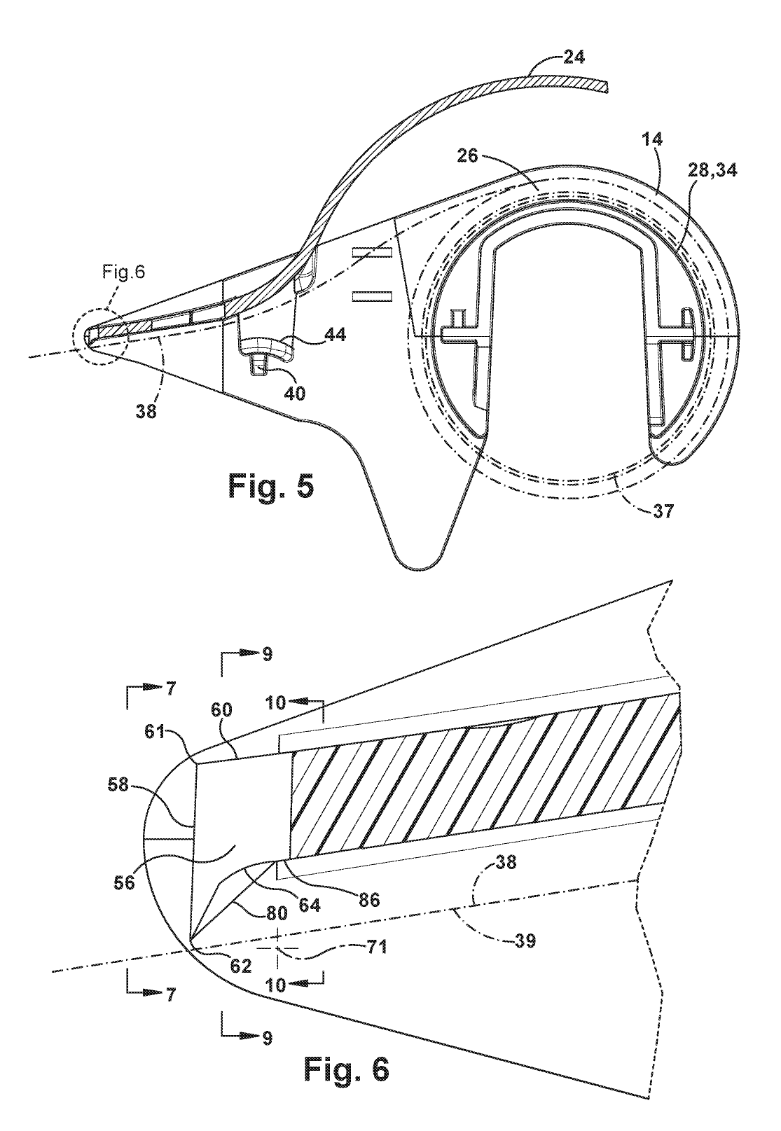

As can be seen in FIGS. 5 and 6, each tooth 52 of the cutting blade 50 projects from the upper surface 60 in a downward direction, as viewed in FIGS. 5 and 6, toward a length of adhesive tape 38 being dispensed from the tape dispenser 10 and passing adjacent the cutting blade. More particularly, the tip 62 of each tooth 52 is located closer to the adhesive tape 38 than any other portion of the tooth, and the tooth is oriented at about 90° or in a range of from about 80° to about 100° relative to the adhesive tape. In addition, the cutting surface 80 of each tooth 52 extends in a direction away from the tip 62 of the tooth and also in a direction toward the left and right roll supports 28 and 32. Further, the cutting surface 80 of each tooth 52 extends at an acute angle to the underside surface 86 of the support member 22.

In use, a roll of adhesive tape 38 is mounted on the left and right roll supports 28 and 32 of the tape dispenser 10. A user of the tape dispenser 10 may then grasp the tape dispenser in one hand with a thumb engaging one of the left and right sidewalls 14 and 16, one or more fingers engaging the other of the left and right sidewalls, and the palm of the user's hand engaging the palm support portion 24. A leading cut edge of the adhesive tape 38 is manually guided over left and right curved guide tabs 40 and 42 and then forward and outward of the cutting blade 50. An adhesive side of the adhesive tape 38 may then be place in contact against and pressed against a surface (not shown), such as an outer surface of a box (not shown) to secure the adhesive tape to the surface. The adhesive tape 38 may then be unwound from the roll and withdrawn from the tape dispenser 10 by manually pulling the tape dispenser away from the location at which the adhesive tape has been secured to the surface.

When the user determines that a sufficient length of adhesive tape 38 has been dispensed and the dispensed length of adhesive tape should be cut off from the roll, the user manually moves the tape dispenser 10 in a direction toward the length of adhesive tape passing through the dispenser below the cutting blade 50 or, in other words, in a direction generally downward adjacent the cutting blade 50, as viewed in FIG. 4. The angle at which the cutting blade 50 and its teeth 52 move toward the adhesive tape 38 may be, for example, about 90° or in a range of from about 80° to about 100°. As the tape dispenser 10 is moved toward the adhesive tape 38, the adhesive tape will be positioned close to the underside surface 86 of the blade support 22. When the tips 62 of the teeth 52 contact the adhesive tape 38, the adhesive tape will be deflected toward the cutting surfaces 80 of the teeth, but will also be held away from the left and right curved rear surfaces 64 and 70 of the teeth. One or more of the tips 62 of the teeth 52 will pierce or puncture the adhesive tape 38. Others of the tips 62 of the teeth 52 may just contact and frictionally engage the adhesive tape 38 without piercing or puncturing the adhesive tape. The adhesive tape 38 may also wrap around the teeth 52 and contact the cutting surfaces 80, which will also apply pressure to the adhesive tape to help cut, puncture, pierce, or split the adhesive tape. The adhesive tape 38 is free to wrap around the teeth 52 to contact the cutting surfaces 80 because the underside surface 86 is spaced vertically away from the tips 62 of the teeth 52, thereby providing space or clearance for the adhesive tape to wrap around the teeth. As the cutting blade 50 continues to be moved toward and into the adhesive tape 38, the cutting edges 80 of the teeth 52 and the angle 13 between the left and right rear flat surfaces 66 and 68 will help force apart or separate cut edges of the adhesive tape. By puncturing, piercing, and/or cutting the adhesive tape 38 at the closely spaced locations of the tips 62 and the cutting surfaces 80 of the teeth 52, the adhesive tape will be sufficiently weakened that the intervening, intact portions of the adhesive tape will easily rupture, resulting in a relatively clean cut edge.

The foregoing cutting action will occur regardless of whether the user of the tape dispenser 10 holds the cutting blade 50 generally parallel to the adhesive tape 38 and moves the cutting blade so that all of the teeth 52 contact the adhesive tape 38 at the same time or whether the user holds the cutting blade at an angle to the adhesive tape and moves the cutting blade so that only one or more teeth adjacent one end of the cutting blade initially contact the adhesive tape and the remaining teeth are subsequently brought into contact with the adhesive tape. The cutting blade 50 of the tape dispenser 10, when formed of a polymeric material, may be particularly useful in cutting packaging or packing tape that does not include any reinforcing filaments or fibers or other reinforcing material. The film carrier for the adhesive in packaging or packing tape, which may be acrylic film, is typically tougher and more difficult to rupture than the film carrier for light-duty household tape, which may be acetate film.

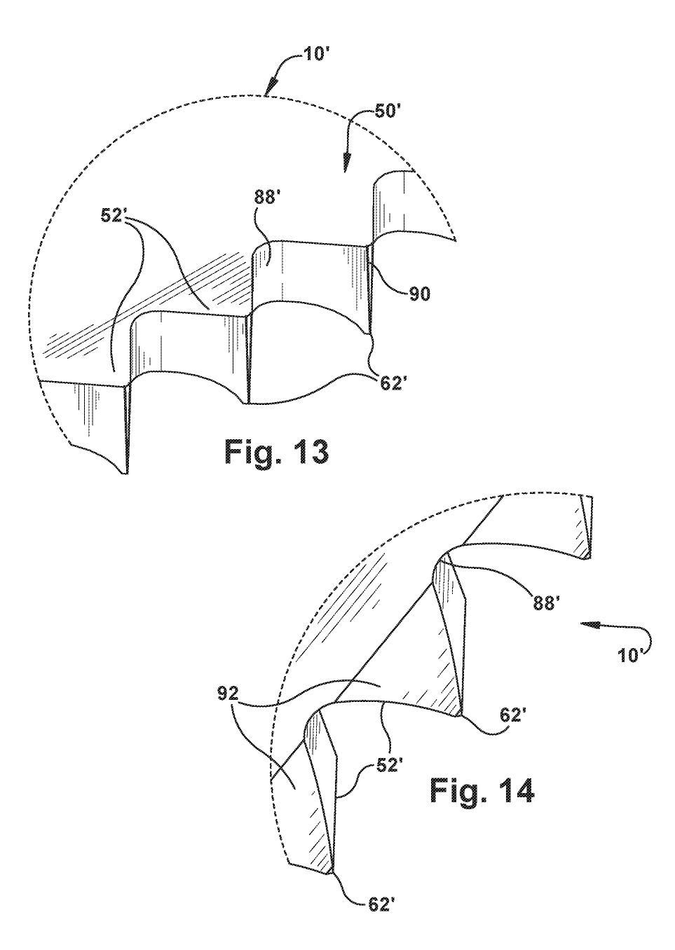

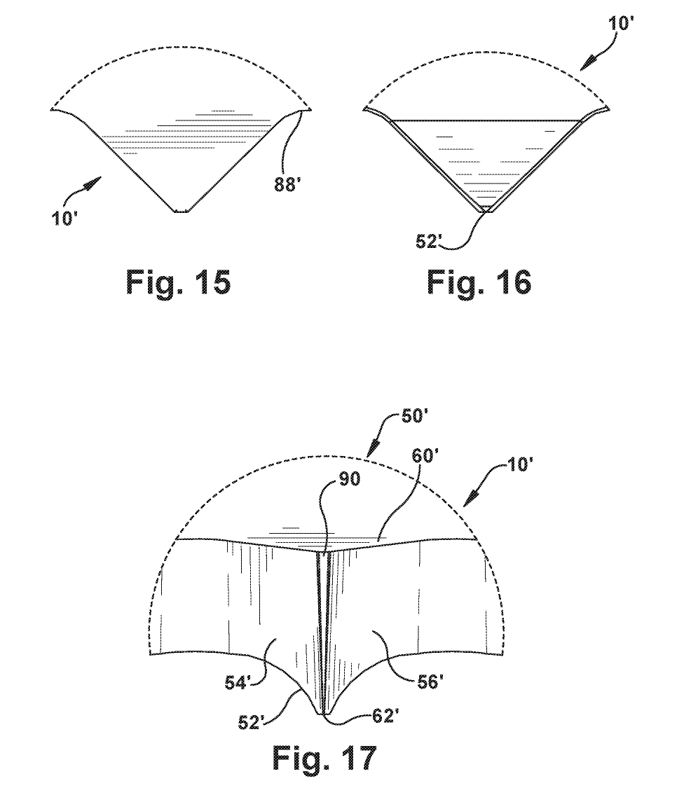

FIGS. 12 to 16 illustrate portions of tape dispenser 10′ in accordance with a second example of the present invention. The tape dispenser 10′ is in all respects identical to the tape dispenser 10 of FIGS. 1-11 except for the configuration of the teeth 52′ of the cutting blade 50″. In FIGS. 12-16, therefore, components or portions of the tape dispenser 10′ corresponding to components or portions of the tape dispenser 10 of FIGS. 1-11 are identified with the same reference numerals with the addition of a prime symbol (′).

As best seen in FIGS. 12 and 16, the left and right front surfaces 54′ and 56′ of each tooth 52′ of the embodiment of FIGS. 12-16 do not come together along a narrow edge 58 as in the embodiment of FIGS. 1-11, but rather have a narrow, flattened triangular face 90 separating the left and right front faces. Also, each tooth 52′ of the embodiment of FIGS. 12-16 lacks the rear flat surfaces 66 and 68 of the embodiment of FIGS. 1-11. As a result, the rear curved surfaces 64 and 70 of the embodiment of FIGS. 1-11 becomes a single continuous curved rear surface 92 in the embodiment of FIGS. 12-16.

While the present invention has been illustrated by the description of embodiments thereof, and while the embodiments have been described, it is not the intention of the applicants to restrict or in any way limit the scope of the appended claims to the details herein. Additional advantages and modifications will readily appear to those skilled in the art. Therefore, the invention, in its broader aspects, is not limited to the specific details, the representative apparatus, and illustrative examples shown and described. The examples of the present invention also includes dispensers or cutting blades used in devices to cut several products, for example rolled products of sheet or film material made of polymer, paper, and adhesives or adhesive-backed substrates. Accordingly, departures may be made from such details without departing from the spirit or scope of the applicant's general inventive concept and which are intended to be encompassed by the following claims.

What is claimed is:

1. A cutting blade comprising a blade support and a plurality of teeth forming a serrated front portion of the blade support, each of the plurality of teeth having a length extending in a direction transverse of the blade support and terminating in a pointed tip.

2. The cutting blade of claim 1, wherein at least one tooth of the plurality of teeth includes a left front surface and a right front surface oriented at an angle relative to one another in a direction transverse to the length of the tooth.

3. The cutting blade of claim 1, wherein at least one tooth of the plurality of teeth includes a rear surface that is curved.

4. The cutting blade of claim 2, wherein the tip of each of said plurality of teeth is spaced vertically away from an underside surface of the blade support, each of said plurality of teeth including a cutting surface extending from the tip of said at least one tooth to the underside surface of the blade support at an acute angle to the underside surface and in a direction away from the left and right front surfaces, the underside surface of the blade support being free of any projection extending vertically in the direction of the tip of said at least one tooth.

5. The cutting blade of claim 1, wherein the plurality of teeth and the blade support are formed in one piece of a single polymeric material composition.

6. A cutting device comprising a cutting blade according to claim 1.

7. A tape dispenser comprising:
a first sidewall;
a second sidewall; and
a cutting blade formed in one piece with the first and second sidewalls, the cutting blade including a plurality of teeth; and
the first sidewall, the second sidewall and the cutting blade are made of polymer.

8. The tape dispenser of claim 7, wherein the tape dispenser is a unitary member comprised of a single material composition.

9. The tape dispenser of claim 8, wherein the single material composition is polycarbonate.

10. The tape dispenser of claim 7, wherein:
the plurality of teeth form a serrated front portion of the cutting blade; and
at least one tooth of the plurality of teeth includes a left front surface and a right front surface oriented at an angle relative to one another.

11. The tape dispenser of claim 10, wherein at least one tooth of the plurality of teeth includes a rear surface that is curved.

12. The tape dispenser of claim 7, wherein each of the plurality of teeth terminates in a pointed tip.

13. The tape dispenser of claim 7, wherein each of the plurality of teeth includes a cutting surface extending in a direction away from the tip of said each tooth and at an angle to a length of said each tooth.

14. The tape dispenser of claim 13, wherein each of the plurality of teeth includes a left front surface and a right front surface oriented at an angle relative to one another, the tip of each of said plurality of teeth being spaced vertically away from an underside surface of a blade support, the cutting surface of each of said plurality of teeth extending from the tip of said at least one tooth to the underside surface of the blade support at an acute angle to the underside surface and in a direction away from the left and right front surfaces, the underside surface of the blade support being free of any projection extending vertically in the direction of the tip of said at least one tooth.

15. A tape dispenser comprising:
a first sidewall;
a second sidewall;
a cutting blade including a plurality of teeth, each tooth including a tip;
a support member for rotatably supporting a roll of adhesive tape in the tape dispenser between the first and second sidewalls; and
a guide member for helping to guide a length of the adhesive tape away from the support member such that the length of adhesive tape passes adjacent the cutting blade with an adhesive side surface of the adhesive tape presented in a direction away from the cutting blade,
each of the plurality of teeth projecting in a direction toward the length of adhesive tape such that the tip of each tooth is closer to the length of adhesive tape than any other portion of the tooth, at least one of the plurality of teeth including a cutting surface extending in a direction away from the tip of said at least one tooth and in a direction toward the support member.

16. The tape dispenser of claim 15, wherein the cutting blade is formed on a forward portion of a blade support, the tip of said at least one tooth being spaced vertically away from an underside surface of the blade support, the cutting surface extending from the tip of said at least one tooth to the underside surface of the blade support, the underside surface of the blade support being free of any projection extending vertically in the direction of the tip of said at least one tooth.

17. A method of cutting a length of product comprising:
passing the product in a first direction adjacent a plurality of teeth projecting in a second direction toward the product such that a tip of each tooth is closer to the product than any other portion of the tooth, at least one of the plurality of teeth including a cutting surface extending in a third direction away from the tip of said at least one tooth and away from the first direction;
moving at least one of the product and the plurality of teeth relative to one another so that the tip of each tooth contacts the product; and
applying pressure to the product through the plurality of teeth so that at least one of the tip of at least one tooth and the cutting surface of at least one tooth passes through the product.

18. A method of manufacturing a product dispenser, the method comprising:
manufacturing a product dispenser body and cutting blade as a unitary product dispenser.

19. The method of claim 18, wherein the method of manufacturing is selected from the group of injection molding and additive manufacturing.

20. The method of claim 18, wherein the method of manufacturing is additive manufacturing.

21. The method of claim 18, wherein the method of manufacturing is injection molding.

22. The method of claim 18, wherein the product is selected from the group of adhesive tape, polymer sheet, polymer film, paper, and adhesive-backed paper.
